(19) United States
(12) Patent Application Publication
(10) Pub. No.: US 2008/0162274 A1
(43) Pub. Date: Jul. 3, 2008

(54) E-tool providing learning distribution

(75) Inventor: Benjamin E. Newman, Kewanee, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/646,549

(22) Filed: Dec. 28, 2006

(51) Int. Cl. G06Q 10/00; G09B 19/00

(52) U.S. Cl. 705/11; 434/365

(57) ABSTRACT

A computer system providing learning distribution is disclosed. The computer system has a platform, at least one input device, and a central processing unit in communication with the platform and the at least one input device. The central processing unit is configured to identify an individual's role and position within an organization and at least one competency required by the role and position. The central processing unit is also configured to determine the individual's proficiency level in the competency and select at least one learning unit from a plurality of available learning units based on the identified proficiency level. The central processing unit is further configured to provide the at least one selected learning unit to the individual for completion.

### TECHNICAL FIELD

The present disclosure is directed to learning distribution, more particularly, to an e-tool providing learning distribution within an organization.

### BACKGROUND

As organizations, such as corporations, become larger and more diversified, they must provide a broad range of training to meet individual needs. For example, an organization may be hierarchically arranged such that it includes a plurality of divisions or business units, and a plurality of departments within each division. Further, each department usually includes many individuals in different roles, each role requiring both unique training focused on the skill sets required by the role, and training generic to the organization. As such, it becomes difficult to ensure individuals receive appropriate job role training while also ensuring training uniformity within the organization. In response, organizations have been seeking ways to improve the distribution of training.

Management personnel usually decide what training is made available to employees within an organization. However, an employee may not be aware of what training is required by, or advantageous to the employee's specific position and career path. Additionally, the training may sometimes be provided irregularly or inconsistently by the organization, and as a result, becoming aware of and taking part in the training may sometimes be left to the initiative of the employee. As such, even though an employee may wish to receive the appropriate training, it may be difficult to do so for lack of an appropriate means to distribute training requirements. Therefore, without an appropriate tool, the process of distributing training to employees may be difficult or ineffective.

One tool that has been developed for providing training to employees is described in U.S. Pat. No. 7,024,154 (the '154 patent) issued to Koepper et al. on Apr. 4, 2006. The '154 patent describes a tool wherein a training coordinator may assign training from a master training database to employees on a group-, department-, or employee-specific basis. Employees can then download and complete the training courses, take exams, and generate a pass/fail certificates. The exam results are then stored in a database. In this manner employee training may be distributed and monitored.

Although the '154 patent alleviates some of the problems discussed above with respect to providing specific training to employees or groups of employees, it is also problematic because the training coordinator must manually assign the courses to be taken by specific employees or groups of employees. Further, if a specific employee in a given group should be excluded from a certain training, the training coordinator must manually exclude that employee from the training group. This can be cumbersome and inefficient. Additionally, an employee may not be receiving training specifically targeted towards his or her career path and advancement within the organization.

The electronic learning distribution tool of the present disclosure addresses one or more of the problems set for above.

### SUMMARY OF THE INVENTION

In accordance with one aspect, the present disclosure is direct toward a tangibly-embodied, computer-readable medium. The computer-readable medium includes instructions for identifying an individual's role within an organization. The medium further includes instructions for identifying at least one competency required by the role and determining the individual's proficiency level in the competency. The medium also includes instructions for selecting at least one learning unit from a plurality of available learning units based on the identified proficiency level, and providing the at least one selected learning unit to the individual for completion.

In another aspect, the present disclosure is directed toward a method of providing training to an individual. The method includes identifying an individual's role within an organization. The method further includes identifying at least one competency required by the role and determining the individual's proficiency level in the competency. The method also includes selecting at least one learning unit from a plurality of available learning units based on the identified proficiency level, and providing the at least one selected learning unit to the individual for completion.

### BRIEF DESCRIPTION OF THE DRAWINGS

FIG. 1 is a block illustration of an exemplary disclosed learning distribution computer system;

FIG. 2 is a schematic illustration of a database included in the disclosed computer system;

FIG. 3 is a schematic illustration of an exemplary browser providing learning information to a user; and

FIG. 4 is a flowchart illustration of an exemplary disclosed method of operating the computer system.

### DETAILED DESCRIPTION

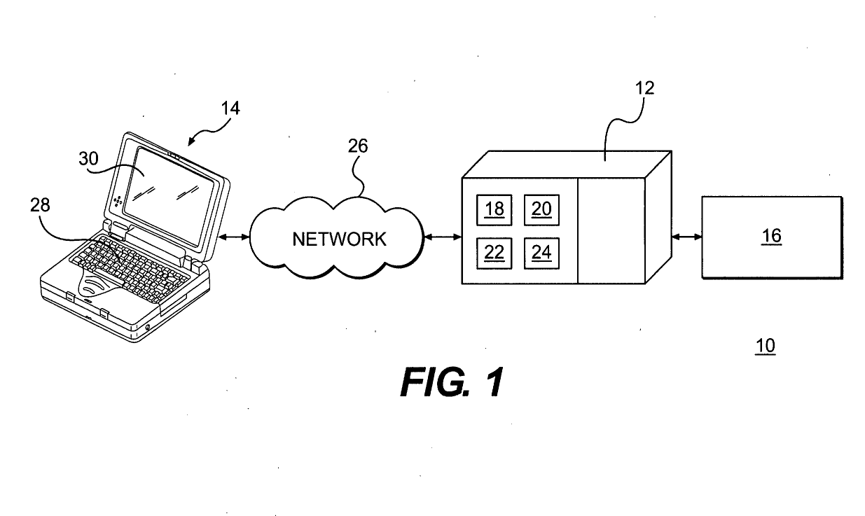

FIG. 1 illustrates e-tool learning distribution system 10. System 10 may include a computing platform 12 operatively coupled to, and in communication with, an input module 14 and/or an output module 16. Computing platform 12 may include or may be otherwise operatively coupled to, and in communication with, a database 18. Database 18 may include more than one database or other type of electronic repository. Computing platform 12 may be adapted to include the necessary functionality and computing capabilities to implement distribution of learning through input module 14, and access, read, and write to database 18.

The results of data received from input module 14 may be provided as output from computing platform 12 to output module 16 for printed display, viewing, and/or further communication to other system devices. Such output may include, for example, a learning catalog, curriculum information, transcript information, a current learning schedule, competencies, proficiency levels, and/or other learning-distribution information obtained from the system for a user's reference. Output from computing platform 12 may also be provided to database 18, which may be utilized as a storage device for distribution of learning to individual users, such as, employees, students, learners, and/or members.

In the embodiment of FIG. 1, computing platform 12 may include a personal (PC) or mainframe computer configured to perform various functions and operations. Computing platform 12 may be implemented, for example, by a general purpose computer selectively activated or reconfigured by a computer program stored in the computer, or may be a specially constructed computing platform for carrying out the features and operations of learning distribution system 10. Computing platform 12 may also be implemented or provided with a wide variety of components or subsystems including, for example, one or more of the following: computer-readable memory 20, secondary computer readable storage device 22, processor(s) 24 (CPU), a register 26, and/or other data processing devices and subsystems. Computing platform 12 may also communicate or transfer information entered by users to and/or from input module 14 and output module 16 through the use of direct connections or other communication links, as illustrated in FIG. 1. In an exemplary embodiment, a firewall may prevent access to the platform by unauthorized outside entities. It is further contemplated that platform 12 may require user authentication, such as password verification, in order to prevent unauthorized users from gaining access to learning information from a particular organization.

In disclosed embodiment, processor(s) 24 may include a single microprocessor or multiple microprocessors for controlling operations or functions of system 10. Numerous commercially-available or specially-constructed microprocessors may be configured to perform the functions of system 10. The microprocessors may store information related to system 10 in hardware, software, firmware, or instructions. Memory 20 may be implemented with various forms of memory or storage devices, such as read-only memory (ROM) devices and random access memory (RAM) devices. Secondary storage device 22 may include a memory tape or disk drive for reading and providing data on a storage tape or disk for use with computing platform 12. It is to be appreciated that other processors(s), memories, and/or storage devices known in the art may be used alternatively or additionally.

It is further contemplated that communication between computing platform 12, module 14, module 16 and/or database 18 may be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 12 may be located in the same location or at a geographically distant location from input module 14, output module 16, and/or database 18.

Input module 14 may include a wide variety of devices to receive and/or provide data as input to computing platform 12. As illustrated in FIG. 1, input module 14 may include an input device 28, a storage device 30, and/or a network interface 32. Input device 28 may include a keyboard, keypad, mouse, touch-screen, disk drive, video camera, magnetic card reader, or any other suitable input device for providing user data to computing platform 12. Storage device 30 may include a memory tape or disk drive for reading and providing data on a storage tape or disk for use with computing platform 12. Network interface 32 may receive data over a network (such as a LAN, WAN, intranet or the Internet) and to provide the same as input to computing platform 12. For example, network interface 32 may be connected to platform 12 and/or a public or private database 18 over a network for the purpose of transmitting information about users.

Output module 16 may include a display 34, a printer device 36, and/or a network interface 38 for receiving the results provided as output from computing platform 12. As indicated above, the output from computing platform 12 may include information, such as, a learning (course) catalog, curriculum information, transcript information, current learning information, competencies, proficiency levels, or other learning-related information obtained from the distribution system 10 for a user's reference. The output from computing platform 12 may be displayed or viewed through display 34 (such as a CRT or LCD) and printer device 36. Network interface 38 may also be configured to facilitate communication of the output from computing platform 12 over a network (such as a LAN, WAN, intranet or the Internet) to remote or distant locations for further analysis, viewing or storing.

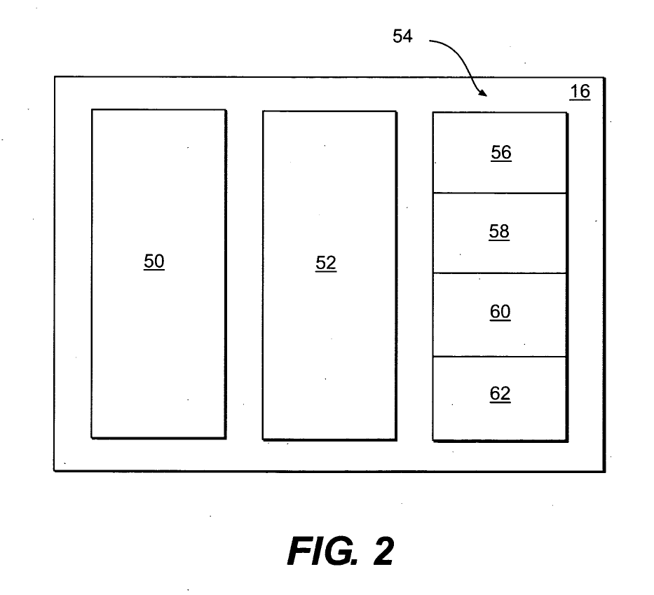

Learning distribution information applicable to users may be stored on database 18 in memory 20 and/or secondary storage device 22. FIG. 2 illustrates one embodiment of database 18. Database 18 may include learning-related information for the entire population of users or selected segments thereof. Database 18 may further include learning-related data directed to individual members of the population, such as, for example, individual employees, students, or learners. The data may include various information that may impact or otherwise relate to different aspects of learning distribution. Although the disclosed database 18 is described in the following with respect to employees of an organization, it is to be appreciated that other individual members of an organization that require learning could be used alternatively or additionally.

In one aspect, database 18 may include organization job role information 50, which may include information about all possible job roles within the organization. For example, each job role may fall within a certain department, which may fall within a certain division, which may fall within an overall enterprise. Each job role may include specific required competencies, which may be divided into, for example, technical (hard) competencies and soft competencies. The competencies may define certain skill sets necessary to perform the job role successfully. Each job role may also have a proficiency level goal or target proficiency level for each of the competencies. The proficiency level goal may define a level of skill required for the competency to ensure the employee may perform satisfactorily and meet the demands of the job role. Additionally, a job role may require the employee to possess or obtain one or more certifications. All such data may be contained within job role information 50.

For example, a job role, such as an accountant, may be within the Accounting Department, which may be within the Global Finance Division, which may be within an overall enterprise, such as, for example, Caterpillar. Certain required technical (hard) competencies may be necessary to the accountant role, such as, for example, Tax Law, Written Communications, Ledger Drafting, etc. Certain required soft competencies may also be necessary to the accountant role, such as, for example, Leadership Skills, Interpersonal Skills, Conflict Resolution, etc. Further, a proficiency level goal may be necessary for each of the competencies, such as for example, novice, intermediate, or expert. Alternatively, the proficiency level goal for each competency may be defined on a numbered scale or the like. Additionally, the accountant job role may require one or more professional certifications, such as, for example, a CPA. It is to be appreciated that the required competencies and respective proficiency level goals of each job role may be a function of both the job role itself, as well as the department, division, and enterprise in which it is situated. In other words, an accountant in the Global Finance Division may have some required competencies and respective proficiency level goals that overlap with an accountant in another division, such as, for example, the Motion, Power, and Control Division, and some that do not, even though both accountants work within the same enterprise (Caterpillar).

Database 18 may also include a learning catalog 52, which may include information about learning provided by the organization. For example, learning catalog 52 may include a listing of at least some available learning units provided by the organization, and various parameters associated therewith. A learning unit may include, for example, a class, course, seminar, lesson, tutorial, or module (a group of such learning units). Each learning unit may be required or may be discretionary (optional) for one or more specific enterprises, divisions, departments, and/or job roles within the organization. Further, each learning unit may be designed to target one or more specific competencies, as well as a certain proficiency level associated with each of the competencies. Each learning unit may also be provided in a certain delivery format, such as, for example, electronically via Internet or Intranet, or instructor-led; at a certain time, date and/or location; and in or more available languages. Preferably, each learning unit contained in learning catalog 52 may be indexed according to an index number; its one or more required and/or discretionary enterprises, divisions, departments, and/or job roles; targeted competencies; targeted proficiency levels; delivery format; time, date, or location; and/or available language(s), in order to facilitate access to, or searching of, learning catalog 52 based on these parameters.

For example, learning catalog 52 may include a course on International Hedge Funding. This course may be required by only the accountant job role in the Accounting Department of the Global Finance Division of Caterpillar (enterprise). International Hedge Funding may target the Tax Law competency at the expert proficiency level. Additionally, this course may be instructor-led; provided in English; and offered on Mondays and Wednesdays, from 6 pm to 8 pm, from September 1^{st} through December 14^{th}, in room 202, of Building 1, etc.

Learning catalog 52 may further include another course, such as, for example, 2006 Corporate Tax Regulations. 2006 Corporate Tax Regulation may be required by all job roles within the Accounting Department of the Global Finance Division. This course may target the Tax Law competency at the intermediate proficiency level. This course may also be instructor-led and offered at various times and locations, and/or in various languages.

Learning catalog 52 may include another course, such as, for example, General Ledger Preparation. General Ledger Preparation may be required by all job roles within the Global Finance Division. General Ledger Preparation may also target the Tax Law competency, but at the novice proficiency level. This course may be an electronic Intranet-based lesson and launched at any desired time in various languages.

Learning catalog 52 may further include a course, such as, for example, Effective Electronic Communications, which may be required by all job roles within the entire enterprise (Caterpillar). Effective Electronic Communications may target the Interpersonal Skills competency at the novice proficiency level. This seminar may be instructor-based and offered at multiple times, locations, and/or in various languages.

Learning catalog 52 may further include a course module, such as, for example, Basic Electricity Module 3: Measuring Electrical Circuits. This module may be required of all electrical engineers in the Research and Development Department of the Motion, Power and Control Division of the enterprise (Caterpillar). Basic Electricity Module 3 may target the Electronics Design competency at the novice proficiency level. The module may be an electronic Intranet-based lesson and launched at any desired time in various languages. Learning catalog 52 may similarly include information about any other learning unit offered by the organization.

In another aspect, learning catalog 52 may also include evaluation materials. The evaluation materials may include any type of activity or tool that may be used to compare or assess an employee against a baseline with respect to each learning unit, competency, associated proficiency level, job role, department, division, enterprise, and/or other employees within the organization. For example, the evaluation materials may be used to identify gaps between an employee's current proficiency level and a target proficiency level for a given competency required for the employee's job role. The evaluation materials may include, for example, one or more of tests, exams, surveys, quizzes, assignments, performance reviews, and/or any reports thereof. Alternatively or additionally, the evaluation materials may simply include informal observations by a peer, supervisor, and/or designated administrator based on the individual's skills, education, and/or past experience. It is to be appreciated that other evaluation materials known in the art may be used alternatively or additionally.

The evaluation materials may comprise paper documents, electronic documents, Internet-based documents, and/or any other suitable media for documentation. The evaluation materials may be administered to individuals within the user population via various modes of transmission, such as email. Internet-based documents may include word processor type files and/or web pages, which may include the evaluation materials. Administration of such documents may include notifying members in any suitable way of the availability and/or accessibility of such documents, including updating existing content and/or providing an Internet and/or Intranet address to access the documents.

Database 18 may also include information 54 about each employee within the user population. For example, employee information 54 may include position information 56 containing the enterprise, division, department, and job role in which each employee is situated. Further, individual position information 56 may include the employee's current competencies and respective proficiency levels, as well as any certifications possessed. For example, an employee may be an accountant in the Accounting Department of the Global Finance Division of the enterprise (Caterpillar). Additionally, the employee may currently have an expert proficiency level in Tax Law, and an intermediate proficiency level in Written Communications, General Ledger Preparation, Leadership Skills, Interpersonal Skills, and Conflict Resolution. The employee may also possess a professional CPA certification. Position information 56 may be indexed in the same manner as discussed above in connection with learning catalog 52 in order to facilitate access thereto and/or searching thereof based on the job role, department, division, and/or enterprise in which each employee is situated, current competencies, proficiency levels, and/or certifications. It is to be appreciated that any other competencies, proficiencies, certifications, and/or other relevant data about each employee may also be contained within position information 56.

Employee information 54 may also include transcript information 58 about each employee in the user population. Transcript information 58 may contain, for example, a listing of each learning unit completed, the delivery format thereof, the competencies targeted and respective proficiency levels targeted by the units, grades received in the units, dates the units were completed, and/or certifications received from completion of the learning units. For example, transcript information 58 for the employee discussed above may include that the employee completed a course in Tax Law Basics, which targeted the Tax Law competency at a novice proficiency level. Transcript information 58 may also indicate that Tax Law Basics was completed in a Intranet-based format on May 15, 2004, and the employee received an “A” grade. Additionally, transcript information 58 may indicate that the employee completed an instructor-led course in International Hedge Funding on Dec. 14, 2005, which also targeted the Tax Law competency, but at the expert proficiency level, and that the employee received a “B+” grade. Transcript information 56 may also include data regarding the results of evaluation materials completed in connection with the learning units. Transcript information 56 may similarly indicate any additional learning completed by the employee.

Employee information 54 may also include a current learning schedule 60 for each employee in the user population. For example, learning schedule 60 may indicate a current learning period, such as, for example, a current semester or trimester. Learning schedule 60 may further include a listing of the names index numbers, delivery formats, target completion dates, as well as scheduling information, such as, times, dates, and locations of each learning unit the employee is registered to take during the current learning period. Learning schedule 60 may also include the competencies and respective proficiency levels targeted by each learning unit. Learning schedule 60 may further include whether each learning unit is required or discretionary for a specific enterprise, division, department, and/or job role.

For example, current learning schedule 60 for the accountant employee discussed above may indicate that for the current semester (Spring), the employee is registered for Financial Accounting class on Mondays and Wednesdays at 6:00 pm in room 307 of building 1; in an instructor-based format; to be completed by Jun. 23, 2006. Current learning schedule 60 may further include that Financial Accounting targets the Tax Law competency at the intermediate proficiency level. Learning schedule 60 may also indicate that Financial Accounting is a required unit for the all job roles in the Accounting Department of Global Finance Division of Caterpillar (enterprise). Current learning schedule 60 may also indicate that the employee is registered for Negotiation, an instructor-based seminar to be completed by Jun. 23, 2006, which targets the Interpersonal Skills competency at the expert proficiency level. Learning schedule 60 may further indicate that Negotiation is a discretionary learning unit for the accountant job role in the Accounting Department within the Global Finance Division of Caterpillar (enterprise). Current learning schedule 60 may similarly include any additional learning units the employee is currently registered for.

Employee information 52 may also include curriculum information 62 for each employee in the user population. Curriculum information 62 may include a listing of learning units to be completed by each employee in order to satisfactorily meet the requirements of the employee's position and/or job role within the organization. Curriculum information 62 may further indicate a learning period, such as a semester or trimester, in which each learning unit should be taken; a delivery format of each learning unit; an amount of credits associated with each unit; a total number of credits required; a total number of credits remaining; and/or the specific competencies and respective proficiency levels targeted by each unit. Curriculum information 62 may also include dates by which the learning units should be completed. Some learning units may be required to be completed cyclically, such as, for example, annually. In such situations, curriculum information 62 may indicate the appropriate dates and/or learning periods by which the learning units should be completed.

Curriculum information 62 may be a function of organization job role information 50, learning catalog 52 and/or employee information 54. For example, for each employee, computing platform 12 may use employee position information 56 to select appropriate job role information 50 for the employee. Platform 12 may then use job role information 50 to select an initial pool of learning units from learning catalog 52. Subsequently, platform 12 may filter the pool of learning units based individual position information 56, employee transcript information 58, and/or employee learning schedule 60. As such, curriculum information 62 may comprise the filtered pool of learning units. This process will be discussed further in the following section to illustrate the disclosed method of distributing learning.

In one aspect, system 10 may remind employees of learning units to be completed based on information from current learning schedule 60 and/or curriculum information 62. For example, if a certain learning unit is due to be completed by a certain date, system 10 may automatically generate and send a reminder to the employee's desktop, workstation, portable handheld device, cellular phone, etc. The reminders may include one or more of e-mails, instant messages, indications on an electronic calendar, or any other forms of notification known in the art.

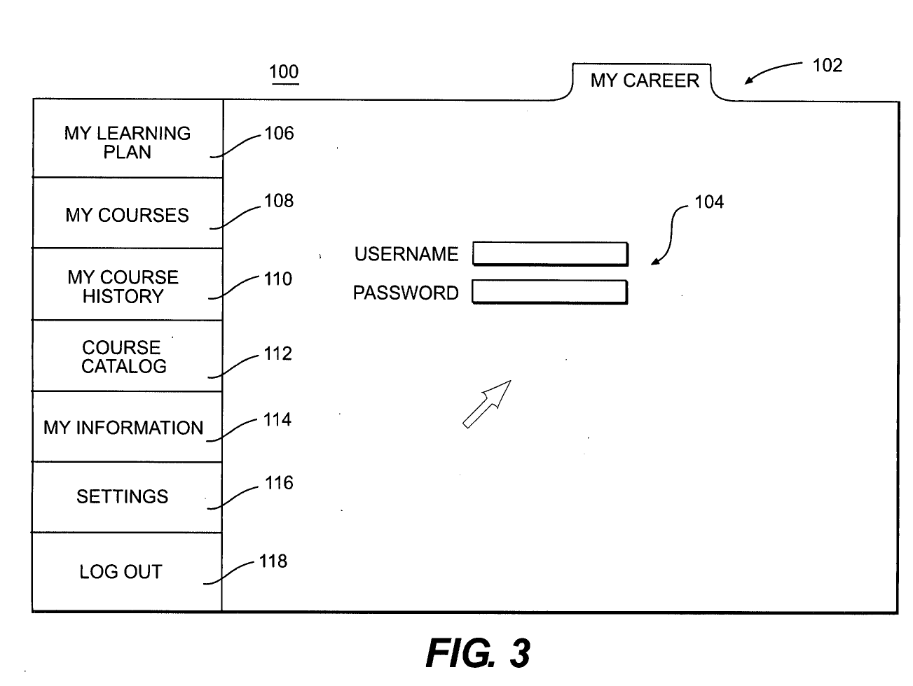

As illustrated in FIG. 3, learning distribution system 10 may access, download, or otherwise gather various types of information from one or more sources. For example, information may be accessed from database 18 and provided to a user through exemplary browser 100 by way of output module 16. Exemplary browser 100 may include an option 102 for viewing, altering, searching, and/or otherwise accessing learning distribution information concerning each member of the user population. For example, an employee may be able to log in through prompt 104. Once logged in properly, one or more options may become available to the employee by way of browser 100.

In one aspect, exemplary browser 100 may include an option 106 to access curriculum information 62. Selection of option 106 may cause browser 100 to display the employee's curriculum information 62. For example, browser 100 may display a listing of learning units to be completed or remain to be completed by the employee in order to satisfactorily meet demands of the employee's job role and/or career within the organization. Browser 100 may also display an index number, number of credits, target completion date, and/or the competencies and respective proficiency levels associated with each learning unit in curriculum information 62. Browser 100 may also provide features allowing curriculum information 62 to be searched, sorted, and/or otherwise accessed based on these parameters. Selection of option 106 may also provide, for example, a registration feature allowing the employee to add a desired learning unit in the curriculum to the employee's current learning schedule 60 through access of learning catalog 52. Additionally, a feature allowing the employee to launch electronic learning units in curriculum 62 from the browser 100 may also be included.

Browser 100 may further include an option 108 to access current learning schedule 60. Selection of option 108 may cause browser 100 to display the employee's current learning schedule 60. For example, browser 100 may display the name; index number; competencies and proficiency levels; delivery format, time, date, and/or location associated with each learning unit the employee is currently registered to take. Browser 100 may also provide features allowing current learning schedule 60 to be searched, sorted and/or otherwise access based on these parameters. Selection of option 108 may also provide features allowing the employee to drop a learning unit from the employee's current learning schedule 60, launch web-based and/or electronic format learning units in current learning schedule 60 from browser 100, and/or view results from evaluation materials associated with the learning units in current learning schedule 60 (indicating progress in the learning units).

Exemplary browser 100 may also include an option 110 to access transcript information 58. Selection of option 110 may cause browser 100 to display the employee's transcript information 58. For example, browser 100 may display a listing of learning units the employee has competed in the past, grades received for the learning units, dates of completion, a number of credits associated with the learning units, competencies and proficiency levels targeted by the units, etc. Selection of option 110 may also include features allowing the employee to access results from past evaluation materials associated with the learning units. Option 110 may also provide a feature allowing the employee to search, sort, and/or otherwise access a past learning units based on, for example, name, index number, grade received, targeted competency and proficiency levels, delivery format, and/or completion date.

Exemplary browser 100 may also include an option 112 to access learning catalog 52. Selection of option 112 may cause browser to display a catalog of learning units provided by the organization. As discussed above, each learning unit within learning catalog 52 may be indexed. As such, selection of option 110 may provide a feature where the employee may search and/or sort learning units according to an enterprise, division, department, and/or job roles for which it is required and/or discretionary. The learning units may also be searched and/or sorted according to index number, targeted competencies and/or proficiency levels, delivery format, time, date, location, and/or available language(s). A desired learning unit from catalog 52 may be added to the employee's current learning schedule 60 through a registration feature, as discussed above.

Exemplary browser 100 may also include an option 114 to access employee position information 54. Selection of option 112 may cause browser to display information about the employee. For example, selection of option 114 may cause browser 100 to display the employee's current job role, and the department, division, and/or enterprise in which the employee is situated. Selection of option 114 may also cause browser 100 to provide a listing of the current competencies and respective proficiency levels and/or certifications the employee has achieved. Additionally, browser 100 may indicate any competency, proficiency level, and/or certification goals for the employee.

It is to be appreciated that browser 100 may also include additional options, such as, for example, to change settings 116 with respect to how learning distribution information is provided to the user, and/or to log out 118 of system 10. Settings 116, for example, may include one or more selectable video and/or audio preferences. However, any additional options related to the distribution of learning may be provided by browser 100.

The described implementation may include a particular network configuration but embodiments of the present disclosure may be implemented in a variety of data communication network environments using software, hardware, or a combination of hardware and software to provide the processing functions. Those skilled in the art will appreciate that all or part of systems and methods consistent with the present disclosure may be stored on or read from other computer-readable media. System 10 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 10, such as, for example, computing platform 12, database 18, memory 20, secondary storage device(s) 22, processors(s) 24, register 26, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

Implementation of the disclosed learning distribution system 10 may be, to some extent, undertaken manually. For example, designated persons, such as administrators within the organization, may determine organization job role information 50. Specifically, the administrators may provide the layout and/or organizational relationship between the job roles, departments, divisions, and/or enterprises within the organization. Additionally, the administrators may determine the appropriate competencies and respective proficiency level goals required by each job role, department, division, and/or enterprise. Further, the administrators may populate learning catalog 52 with the appropriate learning units that are tailored to meet the needs of the organization and/or job roles. Additionally, the administrators may assign competencies and respective proficiency levels to each of the learning units. The administrators may also chose the manner in which an employee is assessed for each learning unit, competency, and/or respective proficiency level by designing and/or selecting the type of evaluation materials used. It is contemplated, however, that either a manual, semi-computerized, or fully computerized implementation may be utilized.

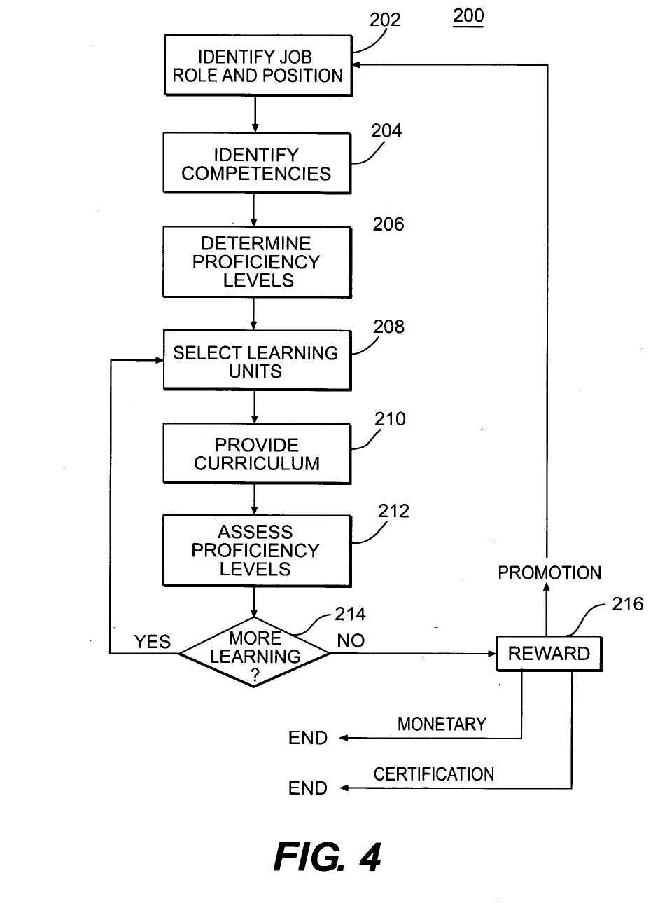

FIG. 4 illustrates a flowchart 200 depicting an exemplary method that utilizes the learning distribution system 10 to distribute learning to a user. The method depicted in flowchart 200 will be described in more detail below.

### INDUSTRIAL APPLICABILITY

The disclosed method and system may find potential application in any organization where individual learners, such as employees or students, may have both unique and overlapping learning requirements based on certain factors, such as their job role, position within the organization, and current competencies or proficiency levels. The disclosed method and system may be particularly useful in situations where individual learners may benefit from receiving, based on these factors, a curriculum of learning designed to ensure they are able to satisfactorily meet the demands of their specific job roles and careers within the organization. As such, individuals may be prepared for their responsibilities and feel satisfied with their organizations' investment in their learning, while the organizations may realize the benefit of a competent, uniformly trained workforce.

As illustrated in FIG. 4, a first step in the functioning of learning distribution system 10 may include identifying the employee's job role information (Step 202). Processor 24 may access employee position information 56 in order to identify the employee's job role. Processor 24 may use an identification number, such as an employee identification number, to look up the employee's position information 56 on database 18. In one aspect, processor 24 may identify the job role, department, division, and enterprise in which the employee is positioned. For example, in the accountant example discussed above, processor 24 may receive information indicating that the employee is an accountant in the Accounting Department of the Global Finance Division within Caterpillar (enterprise). This received information may be stored in processor(s) 24, primary storage memory 20, and/or secondary storage device 22 for following steps.

In a second step, processor 24 may identify the competencies required for the received job role (step 204). In one aspect, processor 24 may look up the job role information identified in step 202 within organization job role information 50, and identify the competencies that are associated therewith by accessing the index of job role information 50. For example, in the accountant example discussed above, processor 24 may determine that the required technical (hard) competencies for the received job role information 56 include Tax Law, Written Communications, and Ledger Preparation. Processor 24 may also determine that the required soft competencies for the received job role information 56 include Leadership, Interpersonal Skills and Conflict Resolution. These identified competencies may be stored in processor(s) 24, memory 22, and/or secondary storage device 22 for subsequent steps.

In a third step, processor 24 may determine a proficiency level of the employee in at least one of the required competencies determined in the previous step (step 206). In one aspect, one or more of the evaluation materials may be administered to specifically assess the employee's proficiency level in each of the competencies determined in step 204. As discussed above, the evaluation materials may include electronic-, web-, or paper-based tests, quizzes, examinations, or surveys; observations; and/or reviews by a peer or supervisor, etc. The results of the employee's performance on the evaluation materials may be used to determine the proficiency levels. The employee's position information 56 and/or transcript information 58 may be automatically and/or manually updated with the results by processor 24. Further, this information may be stored in processor(s) 24, memory 22, and/or secondary storage device 22 for subsequent steps.

For example, in the accountant example discussed above, the employee may be given a comprehensive Tax Law exam, a memorandum writing assignment, and a quiz in preparing a detailed ledger based on company records in order to evaluate the employee's proficiency levels in the required technical (hard) competencies. Based on results of the employee's performance on these evaluation materials, it may be determined that the employee is a novice in Tax Law, Written Communications, and Ledger Preparation. Additionally, the employee may complete a self-evaluative Leadership survey, and quizzes in Interpersonal Skills and Conflict Resolution in order to evaluate the employee's proficiency levels in the required soft competencies. This may be supplemented by observations and/or reviews completed by a designated supervisor and/or administrator based on his or her interaction with the employee and/or the employee's past experience (the employee may be charismatic and have past experience as a salesman). Based on results of the employee's performance on these evaluation materials, it may be determined that the employee is of intermediate proficiency in Leadership Skills, Interpersonal Skills and Conflict Resolution.

In a fourth step, processor 24 may select one or more learning units from a plurality of available learning units within learning catalog 52 based on the results of the employee's performance in the evaluation materials (step 208). In one aspect, processor 24 may access and search learning catalog 52 for learning units targeting the required competencies determined in step 204 at the respective proficiency levels thereof determined in step 206. Processor 24 access and search of learning catalog 52 may be facilitated by the index, as discussed above. Processor 24 may mark, tag, retrieve or otherwise select the appropriate learning units during completion of the search. These selected learning units may be stored in processor(s) 24, memory 22, and/or secondary storage device 22 for subsequent steps.

For example, in the accountant example discussed above, processor 24 may access and search learning catalog 52 for learning units indexed to Tax Law, Written Communications, and Ledger Preparation at the novice proficiency level, and to Leadership Skills, Interpersonal Skills and Conflict Resolution at the intermediate proficiency level. Based on this search, processor 24 may select learning units such as Tax Law Basics, Effective Letter Writing, Ledger Basics, Making Great Leaders, Public Speaking, and Diffusing the Situation, respectively. It is to be appreciated that one or more learning units may be selected for each competency and proficiency level.

In a fifth step (step 210), computing processor 24 may populate and/or update the employee's curriculum information 62 with the learning units selected in step 208. Processor 24 may then provide to the employee a curriculum including the selected learning units. In one aspect, the curriculum may be provided to the employee by way of option 104 discussed above in connection with exemplary browser 100. It is to be appreciated that the employee may be able to view the curriculum, as well as complete registration tasks with respect to each of the selected learning units in the curriculum, as discussed above.

Upon completion of one or more learning units within the curriculum, the employee may be re-evaluated or tested in a sixth step (step 212). The re-evaluation may be designed to determine if the employee may successfully perform at the proficiency level for each of the competencies determined in step 206 (i.e. whether the employee is prepared for the next proficiency level). Re-evaluation may include administering evaluation materials as discussed above in connection with step 206 in order to assess the employee's proficiency level in each of the competencies. Alternatively or additionally, re-evaluation may include assessing the employee's performance in each of the learning units, such as, for example, grades or evaluations received during completion of the learning units. Results of the re-evaluation may include updated proficiency levels of the employee for each of the determined competencies. In some cases, re-evaluation may show that the employee may not be prepared for the next proficiency level in one or more competencies. As such, the updated proficiency levels may be the same as the proficiency levels determined in step 206 for these competencies. Accordingly, processor 24 may update employee position information 56 to include the updated proficiency levels.

For example, in the accountant case above, re-evaluation may show that the employee is prepared for the intermediate proficiency level in Written Communications and General Ledger Preparation, but not Tax Law (still a novice). Additionally, reevaluation may show that the employee is prepared for the expert proficiency level in Leadership, Interpersonal Skills, Conflict Resolution.

In a seventh step, computing processor 24 may determine if additional learning by the employee is needed (step 214). In one aspect, processor 24 may access job role information 50 for the employee's specific job role and position, and determine the proficiency level goal (target proficiency level) for each required competency. Processor 24 may then compare each of the employee's updated proficiency levels with the respective proficiency level goal (target proficiency level) for each competency required the job role. For example, if the updated proficiency level for a specific competency is lower than the goal, additional learning may be required, and platform may then initiate selection of appropriate learning units again (step 208).

For example, in the accountant case above, the proficiency level goal for each of Tax Law, Written Communications, and Ledger Preparation may be expert, while the proficiency level goal for each of Leadership, Interpersonal Skills, and Conflict Resolution may be intermediate. As such, processor 24 may determine that the employee needs additional learning in Tax Law, Written Communications, and Ledger Preparation, as the employee has a novice, intermediate, and intermediate proficiency level in each of these competencies, respectively.

In another aspect, processor 24 may determine that additional learning is unnecessary. For example, the employee may have achieved the proficiency level goal in each of the competencies required by the employee's job role and position. In one aspect, the employee may have been successfully assessed at the proficiency level goal in each of the required competencies during reevaluation (step 212). In such a situation, the employee may be rewarded (step 216). The reward may include, for example, monetary awards such as bonuses and/or raises, and/or receipt of a certification. For example, upon successfully achieving the expert proficiency level in Tax Law, the employee may receive a CPA certification. As such, processor 24 may update employee position information 56 to include the certification.

Alternatively or additionally, the reward may include a promotion in which the employee is promoted to a new job role and/or position within the organization. The new job role and/or position may have different required competencies and respective proficiency level goals. As such, processor 24 may update employee position information 56 and initiate step 202 again in order to repeat the learning distribution process based on the employee's new job role and/or position. For example, the accountant may be promoted to Director of the Accounting Department. The director job role may require expert proficiency levels in each of the Leadership, Interpersonal Skills, Conflict Resolution competencies. Additionally, the director role may require the employee to reach various proficiency levels in a range of management-related competencies.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims.

What is claimed is:

1. A tangibly embodied, computer-readable medium, the computer-readable medium comprising instructions for:
identifying an individual's role and position within an organization;
identifying at least one competency required by the role and position;
determining the individual's proficiency level in the competency;
selecting at least one learning unit from a plurality of available learning units based on the identified proficiency level; and
providing the at least one selected learning unit to the individual for completion.

2. The computer-readable medium of claim 1, further including instructions for:
assessing the individual's proficiency level in the competency upon completion of the learning;
identifying a proficiency level goal for the competency;
comparing the assessed proficiency level to a proficiency level goal; and
determining if the individual needs additional learning based on the comparison.

3. The computer-readable medium of claim 2, wherein assessing a proficiency level includes at least one of a test, an examination, a survey, an observation, or a performance review.

4. The computer-readable medium of claim 2, further including instructions for providing at least one additional learning unit for completion by the individual based on the comparison if additional learning is necessary.

5. The computer-readable medium of claim 2, further including rewarding the individual when additional learning is unnecessary.

6. The computer-readable medium of claim 5, wherein rewarding includes at least one of a certification, a promotion, and a monetary award.

7. The computer-readable medium of claim 1, wherein the plurality of available learning units includes at least one of a class, a course, a lesson, a learning module, and a tutorial.

8. A method of providing training to an individual, comprising:
identifying an individual's role and position within an organization;
identifying at least one competency required by the role and position;
determining the individual's proficiency level in the competency;
selecting at least one learning unit from a plurality of available learning units based on the identified proficiency level; and
providing the at least one selected learning unit to the individual for completion.

9. The method of claim 8, further including:
assessing the individual's proficiency level in the competency upon completion of the learning;
identifying a proficiency level goal for the competency;
comparing the assessed proficiency level to the proficiency level goal; and
determining if the individual needs additional learning based on the comparison.

10. The method of claim 9, wherein assessing a proficiency level includes at least one of a test, an examination, an survey, a observation, or a performance review.

11. The method of claim 9, further including providing at least one additional learning unit for completion by the individual based on the comparison if additional learning is needed.

12. The method of claim 9, further including rewarding the individual when additional learning is unnecessary.

13. The method of claim 12, wherein rewarding includes at least one of a certification, a promotion, and a monetary award.

14. The method of claim 8, wherein the plurality of available learning units includes at least one of: a class, a course, a lesson, a learning module, and a tutorial.

15. A computer system comprising:
a platform;
at least one input device; and
a central processing unit in communication with the platform and the at least one input device, the central processing unit configured to:
identify an individual's role and position within an organization;
identify at least one competency required by the role and position;
determine the individual's proficiency level in the competency;
select at least one learning unit from a plurality of available learning units based on the identified proficiency level; and
provide the at least one selected learning unit to the individual for completion.

16. The computer system of claim 15, wherein the central processing unit is further configured to:
assess the individual's proficiency level for the competency upon completion of the learning;
identify a proficiency level goal in the competency;
compare the assessed proficiency level to the proficiency level goal; and
determine if the individual needs additional learning based on the comparison.

17. The computer system of claim 16, wherein assessing a proficiency level includes at least one of a test, an examination, a survey, an observation, or a performance review.

18. The computer system of claim 16, wherein the central processing unit is further configured to provide at least one additional learning unit for completion by the individual based on the comparison if additional learning necessary.

19. The computer system of claim 16, wherein the central processing unit is further configured to reward the individual when additional learning is unnecessary.

20. The computer system of claim 15, wherein the plurality of available learning units includes at least one of a class, a course, a lesson, a learning module, and a tutorial.
